(19) United States
(12) Patent Application Publication
(10) Pub. No.: US 2005/0012957 A1
(43) Pub. Date: Jan. 20, 2005

(54) Network scanning method and apparatus, and packet format therefor

(76) Inventor: Sang-eun Han, Anyang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/838,206

(22) Filed: May 5, 2004

(30) Foreign Application Priority Data
Jul. 15, 2003 (KR) 2003-48429

(51) Int. Cl. G06F 15/00; G06K 15/00

(52) U.S. Cl. 358/1.15; 358/474

(57) ABSTRACT

A network scanning method and apparatus and a packet format therefor are provided. In the network scanning method, user terminals and scanners, which are indicated by a management multicast address, are registered as members. A device multicast address of each scanner is determined. A user terminal registered as a member determines one or more scanners having a desired scan characteristic based on an advertisement of each of one or more scanners registered as members, registers itself in the determined one or more scanners, designates and reserves a desired scanner among the one or more scanners in which the user terminal has been registered. The reserved scanner receives a document from the user terminal that made reservation, scans the document, transmits a scan result to one or more user terminals indicated by the device multicast address of the reserved scanner.

This application claims the benefit under 35 U.S.C. §119(a) of Korean Patent Application No. 2003-48429, filed on Jul. 15, 2003, in the Korean Intellectual Property Office, the entire disclosure of which is incorporated herein by reference.

### BACKGROUND OF THE INVENTION

1. Field of the Invention

The present invention relates to scanning technology. More particularly, the present invention relates to a method and apparatus for scanning a document through a network, and a packet format therefor.

2. Description of the Related Art

In conventional network scanning methods, a user terminal typically executes a client network scan program to designate a desired scanning apparatus or to find a scanning apparatus having a desired scan characteristic. The user terminal registers the designated or found scanning apparatus locally and registers its own name and unique number for the scanning apparatus. In this situation, if a user commands a scan, the registered scanning apparatus obtains a scan characteristic that was designated by the user from the user terminal, analyzes the scan characteristic, and transmits a scan configuration to the user terminal based on a result of the analysis. Next, according to the scan configuration confirmed by the user, the scanning apparatus scans a document and transmits a scanned image of the document to the user terminal. After completion of such a scan operation, the user can verify the scan image transmitted to the user terminal.

According to conventional network scanning methods, when one user wants to scan a document that another user is scanning, the first user needs to wait until the other user finishes scanning the current document. In other words, according to conventional network scanning methods, a document needs to be repeatedly scanned as many times as the number of users demanding the document, and the result of scanning the document needs to be repeatedly transmitted through a network as many times as the number of users demanding the document. Therefore, conventional network scanning methods have a problem in that resources are inefficiently wasted. In addition, according to conventional network scanning methods, the name of each field of packet data exchanged between the user terminal and the scanning apparatus is formed in a character stream. The character stream can easily be read by a user, but it increases traffic on a network and packet processing time, resulting in an increase in a load on a network scanning apparatus performing a conventional network scanning method.

### SUMMARY OF THE INVENTION

The present invention provides a network scanning method allowing a plurality of user terminals to receive a scan result through a network.

The present invention also provides a network scanning apparatus allowing a plurality of user terminals to receive a scan result through a network.

The present invention also provides a packet format for a network scanning method allowing a plurality of user terminals to receive a scan result through a network.

According to an aspect of the present invention, there is provided a method of scanning a document using at least one scanner connected to at least one user terminal through a network. In the method, user terminals and scanners, which are indicated by a management multicast address, are registered as members. A device multicast address of each scanner is determined. A user terminal registered as a member determines one or more scanners having a desired scan characteristic based on an advertisement of each of one or more scanners registered as members, registers itself in the determined one or more scanners, designates and reserves a desired scanner among the one or more scanners in which the user terminal has been registered. The reserved scanner receives a document from the user terminal that made reservation, scans the received document, and transmits a scan result to one or more user terminals indicated by the device multicast address of the reserved scanner.

According to another aspect of the present invention, there is provided a network scanning apparatus comprising a network, at least one scanner and at least one user terminal which are connected through the network. The network registers user terminals and scanners, which are indicated by a management multicast address, as members. The at least one scanner determines a device multicast address, advertises itself, registers user terminals, receives a document from a user terminal reserving itself, scans the received document, and transmits a scan result to at least one user terminal indicated by the device multicast address. The at least one user terminal determines one or more scanners having a desired scan characteristic using each advertisement received from at least one scanner registered as a member, registers itself in each of the determined one or more scanners, and designates and reserves a desired scanner among the determined one or more scanners in which the user terminal is registered.

According to still another aspect of the present invention, there is provided a packet format transmitted between a user terminal and a scanner through the network in the above-described method. The packet format comprises a first header in which a device multicast address is recorded, and a second header in which a management multicast address is recorded.

### BRIEF DESCRIPTION OF THE DRAWINGS

The above and other features and advantages of the present invention will become more apparent by describing in detail preferred embodiments thereof with reference to the attached drawings in which:

FIG. 1 is a flowchart of a network scanning method according to an embodiment of the present invention;

FIG. 2 is a schematic diagram of a network scanning apparatus performing the network scanning method shown in FIG. 1, according to an embodiment of the present invention;

FIG. 3 is a flowchart of an embodiment of step 12 shown in FIG. 1;

FIG. 4 is a flowchart of an embodiment of step 14 shown in FIG. 1;

FIG. 5 is a flowchart of another embodiment of step 14 shown in FIG. 1;

FIG. 6 is a flow chart of an embodiment of step 62 shown in FIGS. 4 and 5;

FIG. 7 is a flow chart of an embodiment of step 64 shown in FIGS. 4 and 5;

FIG. 8 is a flowchart of a network scanning method according to another embodiment of the present invention;

FIG. 9 is a flowchart of a network scanning method according to still another embodiment of the present invention;

FIG. 10 is a block diagram of an embodiment of each scanner shown in FIG.2;

FIG. 11 is a diagram of a packet format according to an embodiment of the present invention;

FIG. 12 is a diagram of a format of an embodiment of a first header shown in FIG. 11;

FIG. 13 is a diagram of a format of an embodiment of a data portion shown in FIG. 11; and

FIG. 14 is a diagram of a format of another embodiment of the data portion shown in FIG. 11.

### DETAILED DESCRIPTION OF THE INVENTION

The following description concerns a network scanning method according to an embodiment of the present invention.

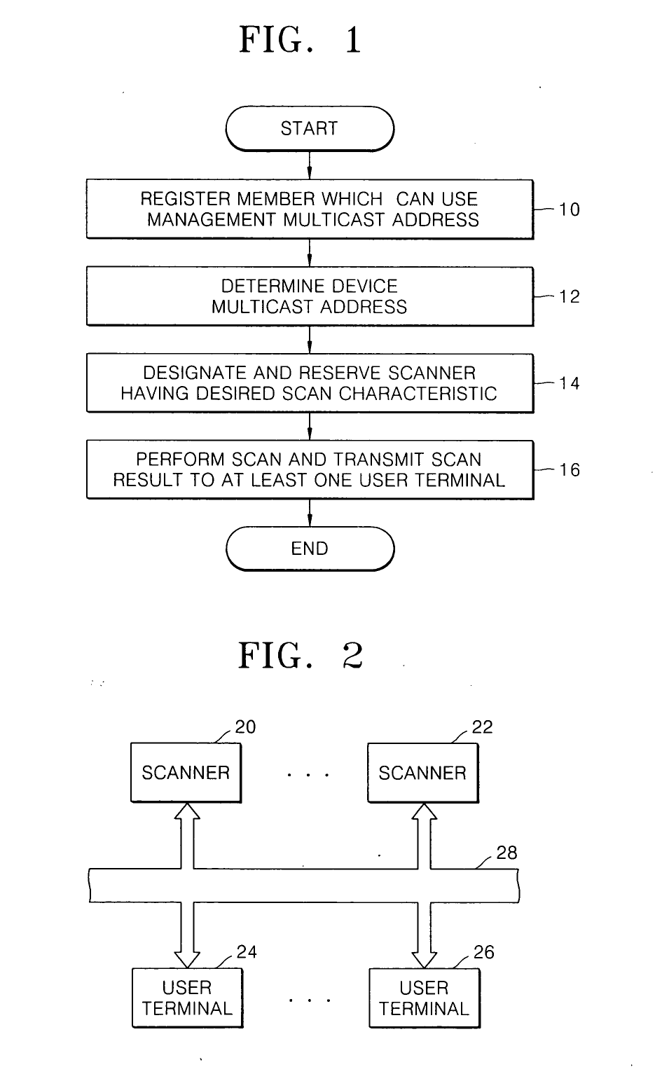

Referring to FIG. 1, the network scanning method according to an embodiment of the present invention includes registering a member indicated by a management multicast address in step 10, determining a device multicast address in step 12, and transmitting a scan result of a reserved scanner to at least one user terminal in steps 14 and 16.

FIG. 2 is a schematic diagram of a network scanning apparatus performing the network scanning method shown in FIG. 1, according to an embodiment of the present invention. Referring to FIG. 2, the network scanning apparatus includes one or more scanners 20 and/or 22, one or more user terminals 24 and/or 26, and a network 28 in a wired or wireless form.

According to a network scanning method of the present invention, the one or more user terminals 24 and/or 26 and the one or more scanners 20 and/or 22, which are indicated by a management multicast address are registered as members in, for example, a router (not shown) on the network 28 in step 10. When packet data is received from the scanner 20 or 22 or a user terminal 24 or 26, the router transmits the packet data to the members indicated by the management multicast address. In other words, when one among the user terminals 24 and 26 and the scanners 20 and 22 forwards data having the management multicast address as a destination address to the network 28, the data can be transmitted to a plurality of user terminals or scanners, which are indicated by the management multicast address.

After step 10, each of the scanners 20 and 22 determines a device multicast address in step 12. The device multicast address is an address of the user terminal 24 or 26 to which the scan result of the scanner 20 or 22 is to be transmitted.

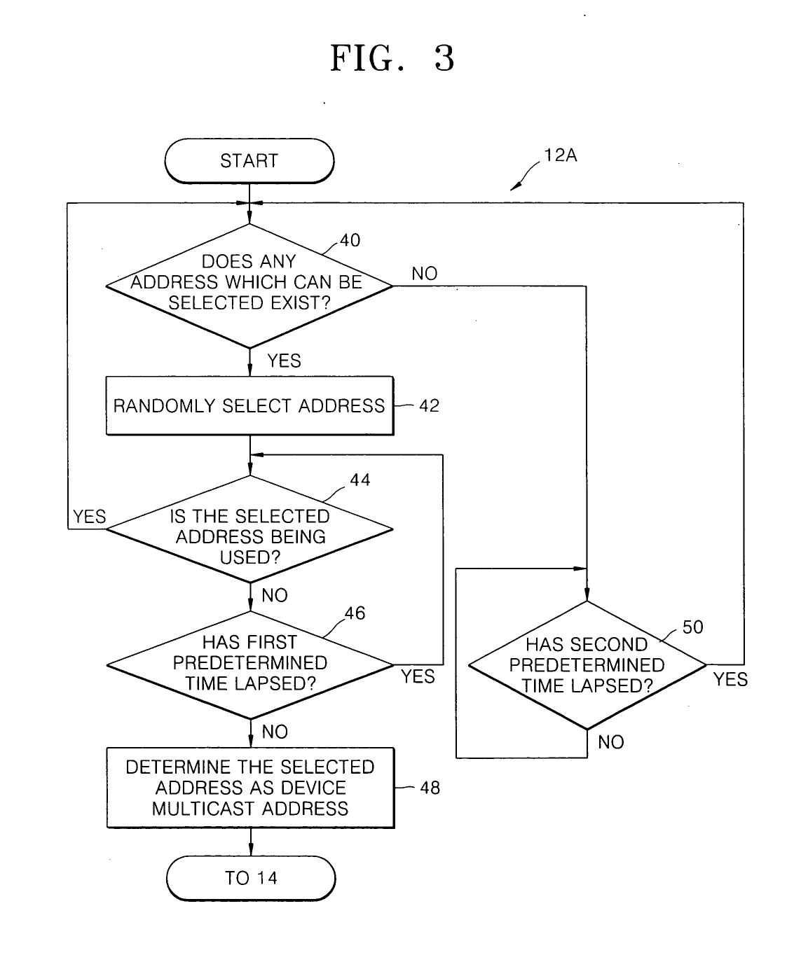

FIG.3 is a flowchart of an embodiment 12A of step 12 shown in FIG. 1, according to an embodiment of the present invention. The embodiment 12A includes determining the device multicast address in steps 40 through 50.

Referring to FIG. 3, after step 10, each scanner 20 or 22 determines whether any address exists in an address pool including the addresses of the user terminals 24 and 26 connected to the scanner 20 or 22 through the network 28 in step 40.

When it is determined that any address which can be selected exists in the address pool, the scanner 20 or 22 randomly selects an address from the address pool in step 42.

Next, the scanner 20 that randomly selects the address determines whether the selected address is being used by the other scanner 22 or the user terminal 24 or 26 in step 44.

An exemplary method of determining whether the randomly selected address is being used will now be described in further detail. The scanner 20 transmits a report that a certain address is selected or transmits the selected address to the other scanner 22 and the user terminals 24 and 26. Then, each of the other scanner 22 and the user terminals 24 and 26 receiving the report or the selected address transmits an address that it is using to the scanner 20. Then, the scanner 20 compares the address transmitted by each of the other scanner 22 and the user terminals 24 and 26 with the selected address to determine whether the selected address is being used currently.

In another embodiment of the present invention, each of the other scanner 22 and the user terminals 24 and 26 receiving the address selected by the scanner 20 in step 42 checks whether the address selected by the scanner 20 is the same as an address that the other scanner 22 or the user terminal 24 or 26 is using currently and informs the scanner 20 whether the selected address is being used.

If it is determined that the selected address is being used by the scanner 22 or the user terminal 24 or 26, the network scanning method returns to step 40. It is then determined whether any other address which can be selected exists in step 40. If it is determined that any other address which can be selected exists, a new address is randomly selected in step 42.

However, if in step 44 it is determined that the selected address is not being used by the scanner 22 or the user terminal 24 or 26, the scanner 20 that selects the address determines whether a first predetermined time has lapsed in step 46. If the first predetermined time has not lapsed, the method returns to step 44 because the selected address may be used by the scanner 22 or at least one of the user terminals 24 and 26 before the first predetermined time lapses. However, when it is determined that the first predetermined time has lapsed, the scanner 20 that selects the address determines the address selected in step 42 as its device multicast address in step 48.

If in step 40 it is determined that no address which can be selected exists, the scanner 20 determines whether a second predetermined time has lapsed in step 50. Step 50 is repeated until the second predetermined time has lapsed. When it is determined that the second predetermined time has lapsed, the scanner 20 returns to step 40 to determine whether any address which can be selected exists. Addresses may be available after the second predetermined time lapses because the use of an address may have finished in the interim.

After step 12, a user terminal registered as a member determines one or more scanners having a desired scan characteristic using an advertisement transmitted from each of one or more scanners registered as members, registers itself in the determined one or more scanners, designates and reserves a desired scanner among the determined one or more scanners in which the user terminal is registered in step 14. To perform step 14, each of the scanners 20 and 22 advertises itself to each of the user terminals 24 and 26 and registers any user terminal wanting its scan characteristic. Here, each of the user terminals 24 and 26 determines one or more scanners having a desired scan characteristic based on the advertisements of at least one of the scanners 20 and 22 registered as members, and registers itself in each of the determined one or more scanners, designates and reserves a desired scanner among the determined one or more scanners in which each user terminal 24 or 26 is registered.

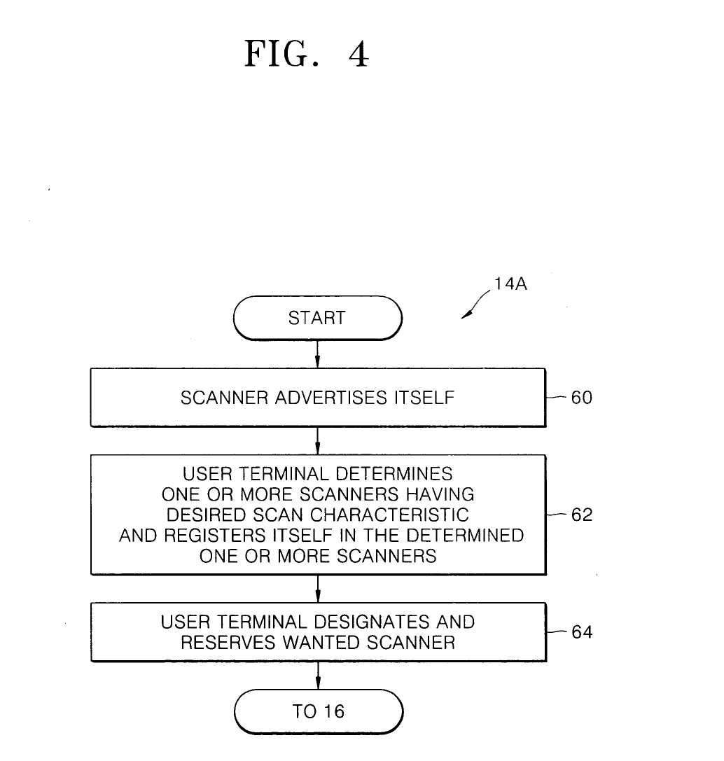

FIG. 4 is a flowchart of an embodiment 14A of step 14 shown in FIG. 1. In the embodiment 14A, each user terminal finds a scanner having a desired scan characteristic using an advertisement transmitted from each scanner and registers itself in the found scanner in steps 60 and 62. Then, the user terminal designates and reserves a desired scanner among the found scanners in which the user terminal is registered in step 64.

More specifically, referring to FIG. 4, each scanner advertises itself to each member indicated by the management multicast address in step 60. After step 60, each of the user terminals registered as members determines one or more scanners having a desired scan characteristic using an advertisement transmitted from each scanner and registers itself in the determined one or more scanners in step 62. After step 62, each user terminal registered as a member designates and reserves a desired scanner among the one or more scanners in which the user terminal is registered in step 64.

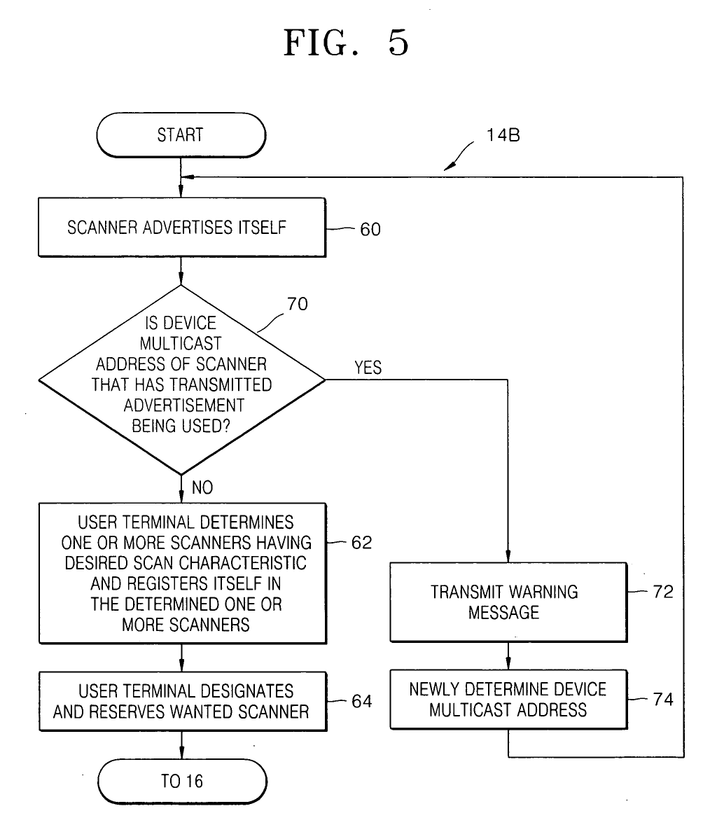

FIG. 5 is a flowchart of another embodiment 14B of step 14 shown in FIG. 1. In the embodiment 14B, each user terminal finds a scanner having a desired scan characteristic using an advertisement transmitted from each scanner and registers itself in the found scanner, designates and reserves a desired scanner among the found scanners in which the user terminal is registered, or receives an advertisement from each scanner again according as the device multicast address of the scanner transmitting the advertisement is being used, in steps 60, 62, 64, 70, 72, and 74.

In other words, step 14 shown in FIG. 1 may be implemented by adding steps 70 through 74 to the embodiment 14A shown in FIG. 4. Steps 60 through 64 shown in FIG. 5 are the same as steps 60 through 64 shown in FIG. 4, and thus descriptions thereof will be omitted.

After step 60, it is determined whether the device multicast address of a scanner that has transmitted an advertisement is the same as a device multicast address which is being used by another scanner in step 70. When it is determined that the device multicast address of a scanner that has transmitted an advertisement is not being used by another scanner, steps 62 and 64 are performed.

However, if it is determined that the device multicast address of a scanner that has transmitted an advertisement is being used by another scanner, the other scanner that is already using the device multicast address transmits a warning message to the scanner that has transmitted an advertisement in step 72. The warning message indicates that “the device multicast address advertised by you is being used.”

After step 72, the scanner receiving the warning message newly determines a device multicast address in step 74, and then the method returns to step 60. A newly determined device multicast address is advertised to each member indicated by the management multicast address. Here, the newly determined device multicast address may be randomly selected from the address pool or may be selected from the address pool in order.

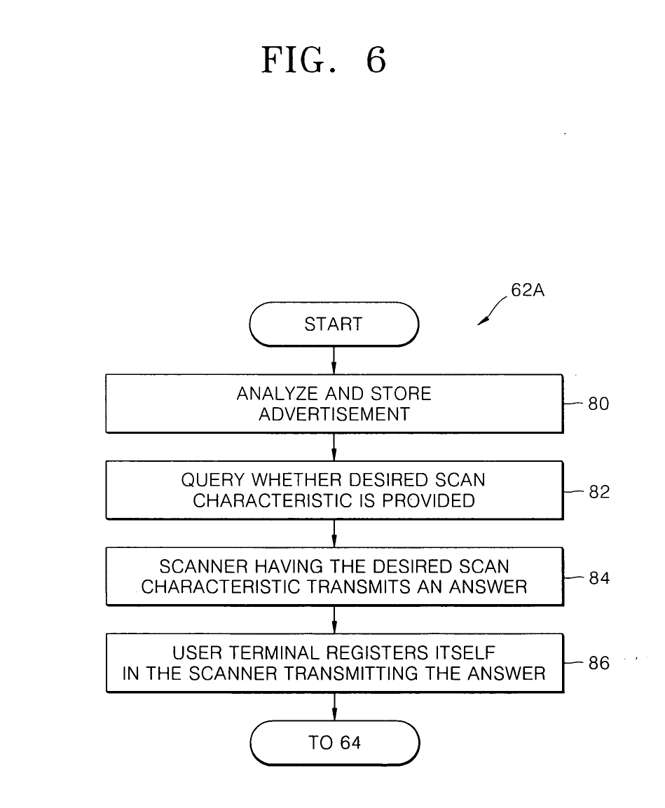

FIG. 6 is a flow chart of an embodiment 62A of step 62 shown in FIGS. 4 and 5. The embodiment 62A includes analyzing and storing the content of an advertisement in step 80, querying whether each scanner has the desired scan characteristic and receiving an answer from a scanner in steps 82 and 84, and registering the user terminal in the scanner transmitting the answer in step 86.

More specifically, referring to FIG. 6, the user terminal registered as the member analyzes the content of an advertisement transmitted from each scanner and stores the result of analysis in step 80. Here, the scanner can update an advertisement and transmit an update advertisement, and the user terminal receives and analyzes the update advertisement and updates a previously stored advertisement with the update advertisement. In other words, an advertisement transmitted from a scanner to a user terminal requesting registration before step 62 shown in FIGS. 4 and 5 is completed is not ignored but is stored as an update advertisement. However, an advertisement transmitted from a scanner to a user terminal requesting registration after step 62 shown in FIGS. 4 and 5 is completed is ignored without being stored as an update advertisement.

After step 80, the user terminal registered as the member transmits a query whether each member has the desired scan characteristic through the network 28 using the stored advertisement to each member in step 82. After step 82, a scanner having the desired scan characteristic transmits to the user terminal an answer indicating whether it has the desired scan characteristic in step 84.

After step 84, the user terminal transmitting the query registers information regarding itself in the scanner transmitting the answer in step 86, and the method goes to step 64. Here, the scanner may optionally verify whether the user terminal to be registered has been permitted registration before registering the user terminal. For this operation, the scanner may previously distribute its unique number only to user terminals permitted registration and then register a user terminal only when the scanner receives its unique number from the user terminal requesting registration.

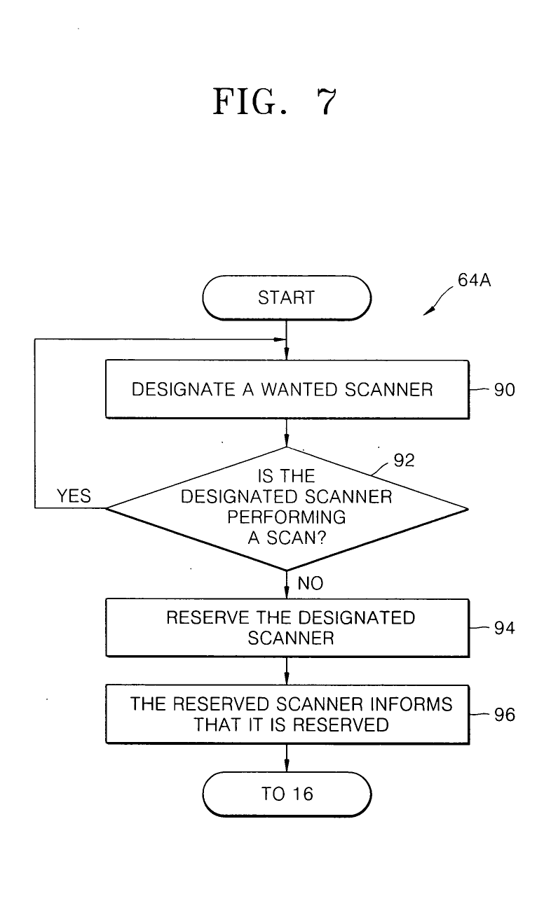

FIG. 7 is a flow chart of an embodiment 64A of step 64 shown in FIGS. 4 and 5. The embodiment 64A includes designating and reserving a desired scanner in steps 90 through 96.

After step 62, the user terminal registered as the member designates a desired scanner among the scanners in which the user terminal is registered in step 90. After step 90, the user terminal determines whether the designated scanner is performing a scan in step 92. If it is determined that the designated scanner is performing a scan, the method returns to step 90 to designate a scanner other than the designated scanner currently performing a scan or to wait until the designated scanner completes the scan.

However, if it is determined that the designated scanner is not performing a scan, the user terminal reserves the designated scanner in step 94. Here, the user terminal transmits the desired scan characteristic to the designated scanner that is not performing a scan.

After step 94, the scanner reserved by the user terminal informs the members indicated by the management multicast address that it has been reserved in step 96, and the method goes to step 16. While the scanner is being reserved, it rejects reservation of other user terminals.

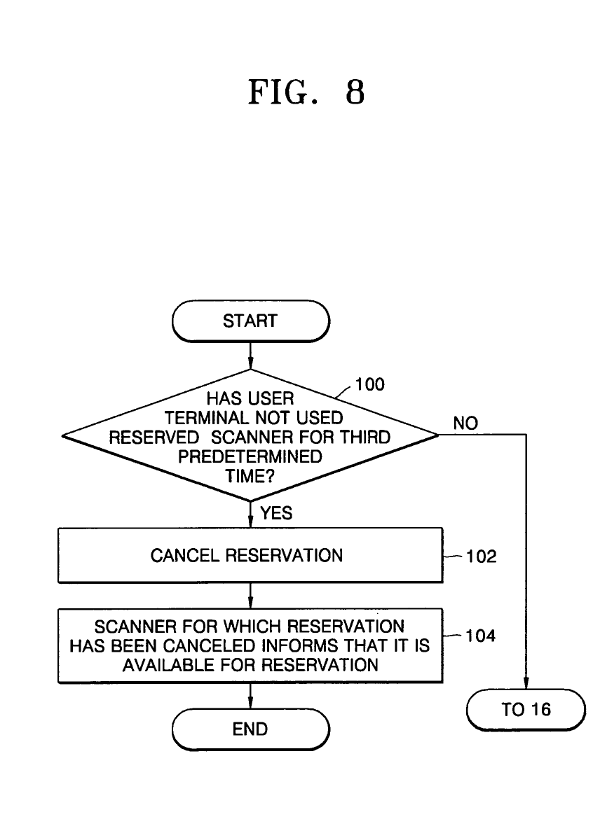

FIG. 8 is a flowchart of a network scanning method according to another embodiment of the present invention. The network scanning method includes canceling reservation when a user terminal that has made the reservation has not used a reserved scanner for a third predetermined time in steps 100 through 104. The network scanning method shown in FIG. 1 may further include steps 100 through 104 shown in FIG. 8.

Referring to FIG. 8, after step 14 shown in FIG. 1, the designated scanner determines whether the user terminal that has made reservation has not used the designated scanner for the third predetermined time in step 100. If it is determined that the user terminal has used the designated scanner within the third predetermined period, the designated scanner scans a document in step 16 shown in FIG. 1. However, when it is determined that the user terminal has not used the designated scanner within the third predetermined period, the designated scanner cancels the reservation in step 102. After step 102, the scanner that cancels the registration informs the members indicated by the management multicast address that it is available for reservation in step 104.

Meanwhile, after step 14, the user terminal logs in the reserved scanner and then transmits a document to be scanned to the logged scanner, and the reserved scanner 20 or 22 receives the document from the user terminal reserving itself, scans the reserved document, and transmits the scan result to one or more user terminals indicated by its device multicast address in step 16. Here, the user terminal logs in the reserved scanner using its name and unique number. The scanner transmits the scan result during the scan.

In step 16, the reserved scanner informs the members of the beginning of the scan and a current scan characteristic when the scan starts and informs the members that reservation for a scan can be made when the current scan is terminated.

According to an embodiment of the present invention, each user terminal receiving the beginning of the scan and the current scan characteristic can receive the scan result only when a user of the user terminal wants the scan result, and the scanner can transmit the scan result only to a user terminal wanting the scan result.

According to another embodiment of the present invention, each user terminal receiving the beginning of the scan and the current scan characteristic can receive the scan result regardless whether a user of the user terminal wants the scan result, and the scanner can transmit the scan result to one or more user terminals indicated by the device multicast address of the scanner.

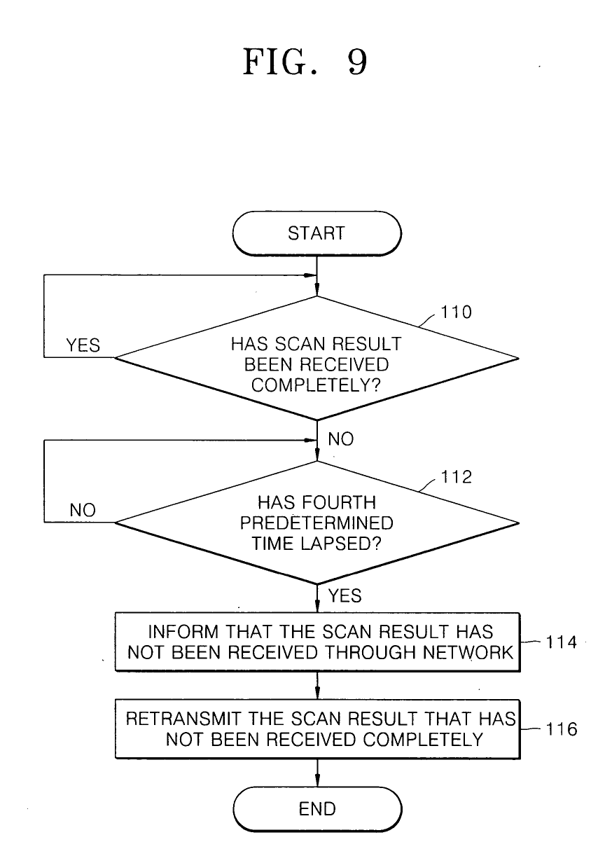

FIG. 9 is a flowchart of a network scanning method according to still another embodiment of the present invention. The network scanning method includes newly receiving the scan result that has not been completely received in steps 110 through 116. The network scanning method shown in FIG. 1 may further include steps 110 through 116 shown in FIG. 9.

Referring to FIG. 9, after step 16, the user terminal receiving the scan result determines whether the scan result has been received completely in step 110. When it is determined that the scan result has not been received completely, the user terminal that has not completely received the scan result determines whether a fourth predetermined time has lapsed in step 112. Thus, the fourth predetermined time can be determined using a coded unique number of the user terminal that has not received the scan result completely. When it is determined that the fourth predetermined time has not lapsed, step 112 is repeated. However, when it is determined that the fourth predetermined time has lapsed, and more specifically, when it is determined that the fourth predetermined time corresponding to the coded unique number of the user terminal that has not received the scan result completely has lapsed, that user terminal informs other user terminals, indicated by the device multicast address of the scanner performing the scan, and the scanner performing the scan that it has not received the scan result completely in step 114.

After step 114, among scanners and user terminals which receive the information that the user terminal has not received the scan result completely, a scanner and a user terminal which stores the scan result transmit the scan result to all user terminals indicated by the device multicast address of the scanner performing the scan in step 116 (not just the user terminal that has not received the scan result completely). Accordingly, not only a user terminal that has not received the scan result completely but also all of the other user terminals indicated by the device multicast address of the scanner performing the scan newly receive the scan result. This is advantageous in that there may be another user terminal that has not received the scan result completely among the user terminals indicated by the device multicast address of the scanner performing the scan.

Here, the scan result that has not been received completely may be newly transmitted by a plurality of scanners and user terminals that store the scan result. In this situation, the user terminal that has not received the scan result completely preferably accepts only the scan result that is received first. For such a case where the scan result is not completely received by a user terminal, each user terminal and each scanner preferably include a storage unit (not shown) which temporarily stores a segment of the scan result and a serial number of the segment. Since the amount of the scan result which can be transmitted once is limited, the scan result is divided into a plurality of segments when it is transmitted. Accordingly, the serial number of the segment indicates a position of the segment in a sequence of segments and is used to assemble the segments of the scan result.

Meanwhile, in the above embodiments of the present invention, user terminals registered in one scanner can converse or exchange information with each other using the device multicast address of the scanner. In addition, each user terminal can inform its user of at least one among its state and a state of the scanner.

According to an embodiment of the present invention, there are some situations in which each of the user terminals 24 and 26 shown in FIG. 2 does not need to store or mange the device multicast address of a scanner in which each user terminal 24 or 26 is registered. These situations include when a scanner advertises itself in step 14, when a user terminal queries whether each member has a desired scan characteristic in step 82, when a scanner having the desired scan characteristic answers in step 86, when a reserved scanner informs that it has been reserved in step 96, and when a scanner that cancels the reservation informs that it is available for reservation in step 104, among others. However, in other cases, each user terminal 24 or 26 needs to store or manage the device multicast address of a scanner in which the user terminal 24 or 26 is registered. For example, when a B user terminal transmits a scan result of an A scanner to an A user terminal that has not received the scan result completely, the B user terminal needs to store and manage the device multicast address of the A scanner to transmit the scan result to user terminals including the A user terminal indicated by the stored device multicast address.

Hereinafter, a structure and operations of a network scanning apparatus of the present invention will be described with reference to the attached drawings.

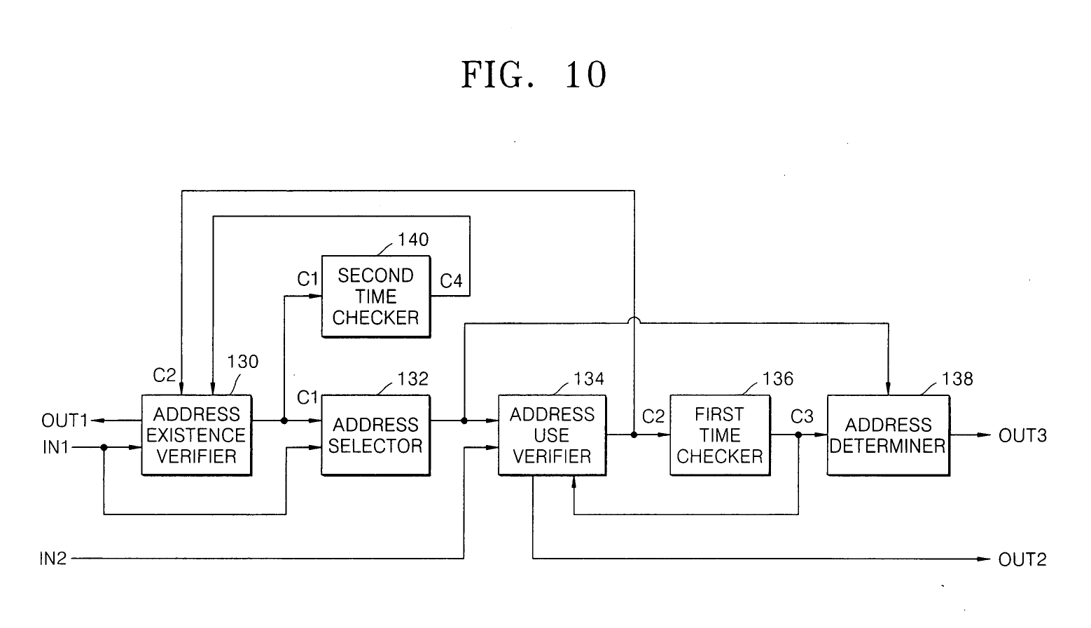

FIG. 10 is a block diagram of an embodiment of each scanner 20 or 22 shown in FIG. 2. The scanner 20 or 22 includes an address existence verifier 130, an address selector 132, an address use verifier 134, a first time checker 136, an address determiner 138, and a second time checker 140. The scanner shown in FIG. 10 performs step 12A shown in FIG. 3.

Referring to FIGS. 3 and 10, to perform step 40, the address existence verifier 130 verifies whether an address which can be selected exists among addresses of the user terminals 24 and 26 connected to the address existence verifier 130 through the network 28 and outputs a verification result as a first control signal C1 to the address selector 132 and the second time checker 140. For the verification, the address existence verifier 130 requests the addresses of the user terminals 24 and 26 through an output terminal OUT1 and receives the addresses from the user terminals 24 and 26 through an input terminal IN1.

To perform step 42, when the address selector 132 determines that an address which can be selected exists based on the first control signal C1 received from the address existence verifier 130, it randomly selects an address among the addresses received through the input terminal IN1 and outputs the selected address to the address use verifier 134 and the address determiner 138.

To perform step 44, the address use verifier 134 verifies whether the address selected by the address selector 132 is being used by the other scanner 20 or 22 or any one of the user terminals 24 and 26 and outputs a verification result as a second control signal C2 to the first time checker 136 and the address existence verifier 130.

In an embodiment of the present invention, to perform step 44, the address use verifier 134 transmits information indicating reception of the selected address from the address selector 132 or the selected address to each of the user terminals 24 and 26 or the other scanner 20 or 22 through an output terminal OUT2. When the other scanner 20 or 22 or each of the user terminals 24 and 26 receives the information or the selected address output from the address use verifier 134, it outputs an address that it is using to the address use verifier 134. Then, the address use verifier 134 receives the address that is being used from the other scanner 20 or 22 or each of the user terminals 24 and 26 through an input terminal IN2 and compares the received address with the selected address to determine whether they are identical.

In another embodiment of the present invention, to perform step 44, the address use verifier 134 receives the selected address from the address selector 132 and outputs it to each of the user terminals 24 and 26 or the other scanner 20 or 22 through the output terminal OUT2. Then, each of the user terminals 24 and 26 or the other scanner 20 or 22 receives the selected address from the address use verifier 134, compares an address that it is using with the selected address to determine whether the addresses are identical, and outputs a comparison result to the address use verifier 134. Accordingly, the address use verifier 134 can verify whether the selected address is being used based on the comparison result received from each of the user terminals 24 and 26 or the other scanner 20 or 22 through the input terminal IN2.

When it is determined that the selected address is being used based on the second control signal C2 received from the address use verifier 134, to perform step 40, the address existence verifier 130 verifies whether an address which can be selected exists among the addresses of the user terminals 24 and 26 connected to the address existence verifier 130 through the network 28.

To perform step 46, the first time checker 136 checks whether the first predetermined time has lapsed when it is determined based on the second control signal C2 that the selected address is not being used and outputs a check result as a third control signal C3 to the address determiner 138 and the address use verifier 134. Then, when it is determined based on the third control signal C3 received from the first time checker 136 that the first predetermined time has not lapsed, the address user verifier 134 verifies whether the selected address received from the address selector 132 is being used by the other scanner 20 or 22 or any one of the user terminals 24 and 26.

To perform step 48, the address determiner 138 determines the selected address received from the address selector 132 as a device multicast address in response to the third control signal C3 received from the first time checker 136 and outputs the device multicast address through an output terminal OUT3. For example, when it is determined based on the third control signal C3 that the first predetermined time has lapsed, the address determiner 138 determines the selected address received from the address selector 132 as the device multicast address.

To perform step 50, when it is determined based on the first control signal C1 received from the address existence verifier 130 that no address which can be selected exists, the second time checker 140 checks whether the second predetermined time has lapsed and outputs a check result as a fourth control signal C4 to the address existence verifier 130. Accordingly, when it is determined based on the fourth control signal C4 that the second predetermined time has lapsed, the address existence verifier 130 performs verification on existence of an address which can be selected.

In the meantime, each of the scanners 20 and 22 performing the network scanning method shown in FIG. 1 can transmit data to and receive data from each of the user terminals 24 and 26 in units of packets. There are preferably several packet types, that include an address selection request packet, an address selection response packet, an advertisement packet, a warning packet, a state packet, a device query packet, a device response packet, a reservation packet, a scan data packet, a retransmission request packet, a retransmission response packet, a chatting packet, and a registration packet.

The address selection request packet and the address selection response packet are used in step 44. The address selection request packet is generated in step 44 using an address selected in step 42 and is transmitted from a scanner performing step 12A shown in FIG. 3 to another scanner or a user terminal. The address selection response packet is generated by the another scanner or the user terminal and transmitted to the scanner performing step 12A in order to inform that the address selected by the scanner performing step 12A is being used.

The advertisement packet is generated in step 60 shown in FIGS. 4 and 5 and includes a unique address of a scanner advertising itself, a device multicast address, and a scan characteristic of the scanner. The advertisement packet is transmitted from the scanner advertising itself to another scanner or a user terminal. The advertisement packet may further include information on the number of users that have been registered in the scanner advertising itself.

The warning packet is generated in step 72 shown in FIG. 5 and may include a warning message such as the warning message described above. The warning packet is transmitted from a scanner that is using the device multicast address of a scanner that has transmitted an advertisement to the scanner that has transmitted the advertisement.

The reservation packet is used in step 94 and includes a scan characteristic desired by a user terminal that wants to make reservation for a scan. The reservation packet is transmitted from the user terminal that wants to make reservation for a scan to a scanner to be reserved.

The scan data packet includes a scan result of a scanner and is transmitted from the scanner to a user terminal indicated by the device multicast address of the scanner.

The state packet indicates a state of each of the scanners 20 and 22 and the user terminals 24 and 26 shown in FIG. 2. For example, the state packet is used in steps 16, 96, and 104 and may include state information indicating that a scanner is available for reservation or that a scanner has been reserved. In other words, when a scanner is performing a scan in step 16 or is reserved in step 94, the state packet can include state information indicating that reservation is impossible in order to inform in step 16 or 96 that the scanner cannot be reserved. In addition, when the scanner completes the scan in step 16 or when the reservation for the scanner is canceled in step 102, the state packet can include state information indicating that reservation is possible in order to inform in step 16 or 104 that the scanner is available for reservation. Moreover, the state packet may include state information indicating whether a scanner operates when it is used in step 16. Here, a reserved scanner can embeds state information indicating the beginning of a scan and a scan characteristic into the state packet and transmit the state packet to a member indicated by a management multicast address when the reserved scanner starts the scan.

The device query packet is used in step 82 shown in FIG. 6 and is transmitted from a user terminal to a member indicated by the management multicast address. The device query packet includes information on a scan characteristic desired by the user terminal. The device response packet is transmitted from a scanner having the scan characteristic desired by the user terminal transmitting the device query packet to the user terminal and includes the same content as the advertisement packet.

The retransmission request packet is used in step 114 and includes a serial number of scan data that is not completely received by a user terminal. The retransmission request packet is transmitted from the user terminal that has not completely received the scan data to another user terminal indicated by the device multicast address and a scanner that has generated the scan data through a scan. The retransmission response packet includes the serial number of the scan data that has not been completely received by the user terminal, a time when the scan data is to be transmitted, and the scan data. The retransmission response packet is transmitted from the scanner performing the scan and user terminal storing the scan data to all user terminals indicated by the device multicast address of the scanner.

The chatting packet includes content of conversation or information, such as a chatting message character stream, exchanged between user terminals registered in one scanner. It is transmitted between user terminals registered in one scanner.

The registration packet is used in step 86 and includes a name and a unique number of a user terminal that wants to be registered in a scanner. The registration packet is transmitted from the user terminal that wants registration to the scanner in which the user terminal is to be registered. When security is requested in the scanner in which the user terminal is to be registered, the registration packet may further include a unique number of the scanner to register only user terminals that has been permitted registration as described above.

Hereinafter, a structure of a packet format used in a network scanning method of the present invention will be described with reference to the attached drawings.

FIG. 11 is a diagram of a packet format according to an embodiment of the present invention. The packet format includes first and second headers 160 and 162 and a data portion 164. The first header 160 includes a device multicast address, and the second header 162 includes a management multicast address. The packet format may further include the data portion 164, as shown in FIG. 11. For example, the address selection request packet and the address selection response packet include only first and second headers 160 and 162 without including the data portion 164. However, other packets, such as the advertisement packet, the warning packet, the state packet, the device query packet, the device response packet, the reservation packet, the scan data packet, the retransmission request packet, the retransmission response packet, the chatting packet, and the registration packet, preferably include all of the first and second headers 160 and 162 and the data portion 164.

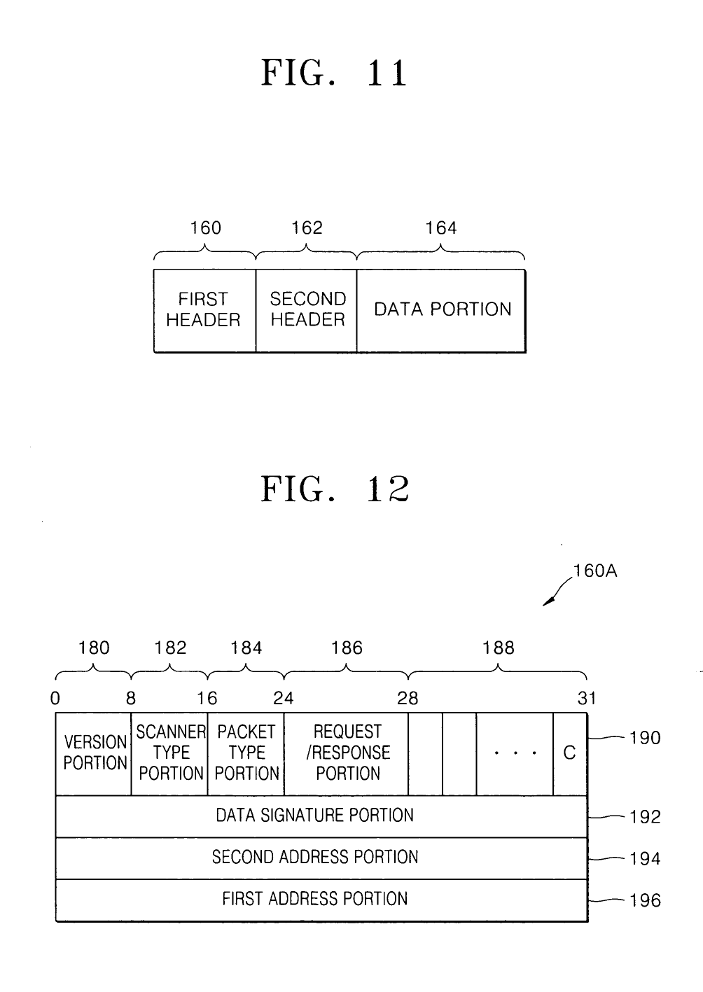

FIG. 12 is a diagram of a format of an embodiment 160A of the first header 160 shown in FIG. 11. The first header 160A includes a version portion 180, a scanner type portion 182, a packet type portion 184, a request/response portion 186, a flag portion 188, a data signature portion 192, a first address portion 196, and a second address portion 194.

In another embodiment of the present invention, the first header 160 may include only the version portion 180, the scanner type portion 182, the packet type portion 184, the request/response portion 186, and the flag portion 188, unlike the format shown in FIG. 12.

A version of a communication protocol is recorded in the version portion 180. A type of scanner is recorded in the scanner type portion 182. For example, a scanner may be a type having only a scan function or a multi function peripheral (MFP) having other functions besides the scan function. Accordingly, a type of scanner is recorded in the scan type portion 182.

Usage of the data portion 164 included in the packet is recorded in the packet type portion 184. In other words, the packet type portion 184 indicates which among the address selection request packet, the address selection response packet, the advertisement packet, the warning packet, the state packet, the device query packet, the device response packet, the reservation packet, the scan data packet, the retransmission request packet, the retransmission response packet, the chatting packet, and the registration packet, the data portion 164 shown in FIG. 11 is for.

An attribute of the data portion 164 is recorded in the request/response portion 186, and an attribute of the first header 160 is recorded in the flag portion 188. For example, when the attribute of the data portion 164 is information, the request/response portion 186 has a value of 0. When the attribute of the data portion 164 is a request, the request/response portion 186 has a value of 1. When the attribute of the data portion 164 is a positive response, the request/response portion 186 has a value of 2. When the attribute of the data portion 164 is a negative response, the request/response portion 186 has a value of 3.

In another embodiment of the present invention, the first header 160 may further include the first and second address portions 196 and 194 shown in FIG. 12.

A device multi flag address is recorded in the first address portion 196, and a unique device address of a scanner is recorded in the second address portion 194. The unique device address can be generated dynamically or passively. Dynamically generating a unique device address means that a network server (not shown) allocates the unique device address to a scanner when power is supplied to the scanner. Passively generating a unique device address means that an administrator of a scanner directly generates the unique device address.

A compression code C 190 indicating an attribute of compression/non-compression of the first header 160 may be recorded in the flag portion 188. In other words, the compression code C 190 indicates whether the first header 160A shown in FIG. 12 includes the first and second address portions 196 and 194. For example, the compression code C 190 represents a value of “1” when the first header 160 is compressed since not including the first and second address portions 196 and 194. The compression code C 190 represents a value of “0” when the first header 160 is not compressed since including the first and second address portions 196 and 194.

For example, as shown in FIG. 12, the version portion 180 is composed of 0th through 7th bits, the scanner type portion 182 is composed of 8th through 15th bits, the packet type portion 184 is composed of 16th through 23rd bits, the request/response portion 186 is composed of 24th through 27th bits, and the flag portion 188 is compose of 28th through 31st bits.

In still another embodiment of the present invention, the first header 160 may further include the data signature portion 192. A signature value obtained using a one-way hash function such as an MD5 is recorded in the data signature portion 192. The MD5 and the one-way harsh function are disclosed in pages 7 and 8 in a book entitled “IPSec, The New Security Standard for the Internet, Intranet, and Virtual Private Networks”, written by Nganand Doraswamy and Dan Harkins, and published by Prentice Hall PTR. For example, when a scanner requests data integrity, that is, when it is intended that data recorded in the data portion 164 is not freely attacked on a network, the first header 160A further includes the data signature portion 192. The one-way harsh function includes a key and data. The key of the one-way harsh function may be a unique number of a scanner, and the data of the one-way harsh function may include a source address, a device multicast address, and a packet type.

Meanwhile, data including at least one among the content of an advertisement, a desired scan characteristic, unique information on a user terminal to be registered, a state of a user terminal or a scanner, and a scan result is recorded in the data portion 164 shown in FIG. 11.

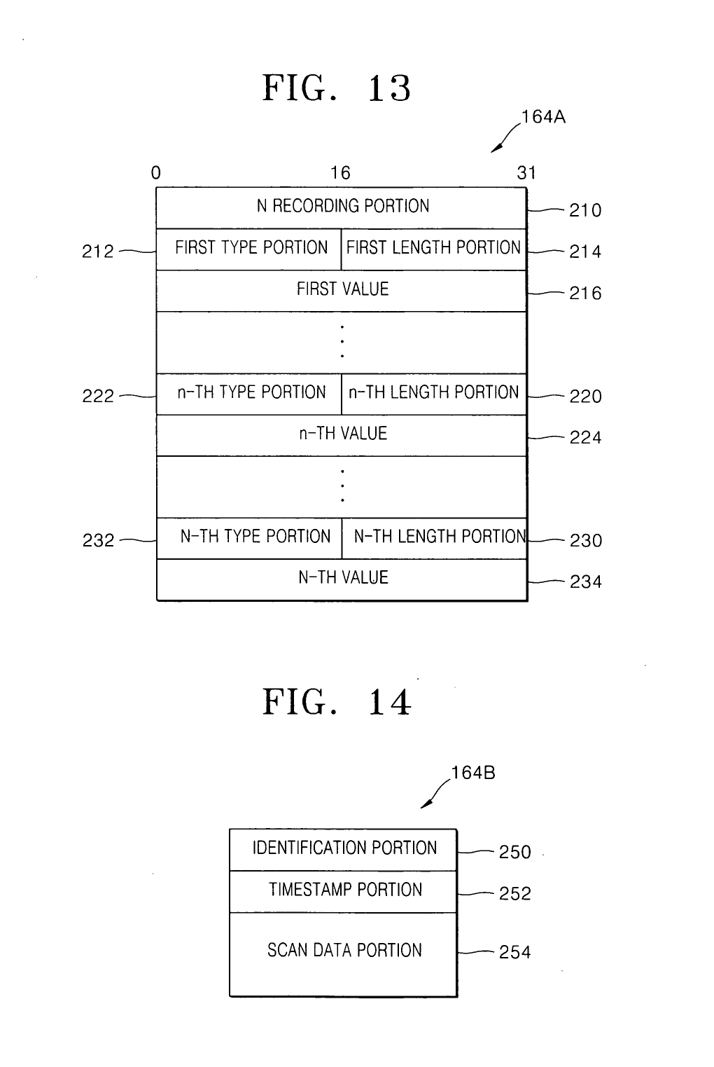

FIG. 13 is a diagram of an embodiment 164A of a format of the data portion 164 shown in FIG. 11, according to an embodiment of the present invention. The data portion 164A includes an N recording portion 210, first through N-th type portions 212, . . . , 222, . . . , 232, first through N-th length portions 214, . . . , 220, . . . , 230, and first through N-th values 216, . . . , 224, . . . , 234.

N is recorded in the N recording portion 210. Data is recorded in the n-th value 224 (where 1≦n≦N). The type of the n-th value 224 is recorded in the n-th type portion 222. The length of the n-th value 224 is recorded in the n-th length portion 220.

For example, as shown in FIG. 13, each of the first through N-th type portions 212 through 232 is composed of 0th through 15th bits, each of the first through N-th length portions 214 through 230 is composed of 16th through 31st bits, and the N recording portion 210 is composed of the 0th through 31st bits.

FIG. 14 is a diagram of another embodiment 164B of a format of the data portion 164 shown in FIG. 11. The data portion 164B includes an identification portion 250, a timestamp portion 252, and a scan data portion 254.

A serial number of a segment of a scan result is recorded in the identification portion 250 of the data portion 164B shown in FIG. 14. A time when the scan result is to be transmitted is recorded in the timestamp 252. The segment of the scan result is recorded in the scan data portion 254 in the form of, for example, a binary bitstream.

The data fields 210 through 234 of each of the data portions 164 and 164A shown in FIGS. 11 and 13 or the data fields 250 through 254 of the data portion 164B shown in FIG. 14 may be recorded in big-endian order and may always have a size of a multiple of four bytes. According to big-endian order, data recorded in the data portion 164, 164A, or 164B is transmitted starting from a most significant bit (MSB). When a small amount of data is recorded in the data portion 164, 164A, or 164B, an empty space in the data portion 164, 164A, or 164B may be filled with padding bytes before the data is transmitted. When a scanner or a user terminal receives data including padding bytes, it removes the padding bytes before processing the packet. A padding byte may be “0”.

Data of the advertisement packet, the warning packet, the state packet, the device query packet, the device response packet, the reservation packet, the retransmission request packet, the retransmission response packet, the chatting packet, and the registration packet is recorded in a format of type-length-value (TLV), as shown in FIG. 13. Data of the scan data packet is recorded in the format shown in FIG. 14.

As described above, according to a network scanning method and apparatus and a packet format therefor according to an embodiment of the present invention, a scan result is allowed to be transmitted to a plurality of user terminals indicated by a device multicast address through a network so that resources can be efficiently used. Since data of a packet has a format of TLV, as shown in FIG. 13, it is difficult for people to read the data, but packet processing time can be reduced without increasing traffic on a network, user terminals registered in one scanner can converse with each other, and the scanner can be protected from invaders.

Although an exemplary embodiment of the invention has been described herein, those of ordinary skill in the art will recognize that certain changes and modifications from what has been described herein can be made while maintaining the spirit of the invention. Therefore, the exemplary embodiments are not intended to be limiting. Rather the scope of the invention is defined in the following claims.

1. A method of scanning a document using at least one scanner connected to at least one user terminal through a network, the method comprising:
(a) registering at least one user terminal and at least one scanner, which are indicated by a management multicast address, as members;
(b) determining a device multicast address of each scanner;
(c) a user terminal registered as a member determining one or more scanners having a desired scan characteristic based on an advertisement of each of one or more scanners registered as members, registering itself in the determined one or more scanners, designating and reserving a desired scanner among the one or more scanners in which the user terminal has been registered; and
(d) the reserved scanner receiving a document from the user terminal that made reservation, scanning the received document, transmitting a scan result to one or more user terminals indicated by the device multicast address of the reserved scanner.

2. The method of claim 1, wherein step (b) comprises:
(b1) each scanner determining whether one or more addresses which can be selected exist among addresses of user terminals connected to the scanner through the network;
(b2) if it is determined that an address which can be selected exists, randomly selecting an address among the one or more addresses which can be selected;
(b3) determining whether the selected address is being used by another scanner or a user terminal and, if it is determined that the selected address is being used by another scanner or a user terminal, going to step (b1);
(b4) if it is determined that the selected address is not being used by another scanner or a user terminal, determining whether a first predetermined time has lapsed;
(b5) if it is determined that the first predetermined time has lapsed, determining the selected address as the device multicast address of the scanner; and
(b6) if it is determined that an address which can be selected does not exists, determining whether a second predetermined time has lapsed and, when it is determined that the second predetermined time has lapsed, going to step (b1).

3. The method of claim 1, wherein step (c) comprises:
(c1) each scanner registered as a member transmitting its advertisement to other members indicated by the management multicast address;
(c2) each user terminal registered as a member determining one or more scanners having a desired scan characteristic based on the advertisement of each scanner and registering itself in the determined one or more scanners; and
(c3) the user terminal registered as the member designating and reserving a desired scanner among the one or more scanners in which the user terminal has been registered.

4. The method of claim 3, wherein step (c) further comprises:
after step (c1), determining whether the device multicast address of the scanner transmitting the advertisement is the same as that of another scanner and, if it is determined that the device multicast address of the scanner transmitting the advertisement is not the same as that of another scanner, going to step (c2);
if it is determined that the device multicast address of the scanner transmitting the advertisement is the same as that of another scanner, the another scanner transmitting a warning message to the scanner transmitting the advertisement; and
the scanner receiving the warning message, newly determining a device multicast address, and going to step (c1).

5. The method of claim 3, wherein step (c2) comprises:
each user terminal registered as the member analyzing content of the advertisement and storing an analysis result;
each user terminal registered as the member transmitting a query whether each of the members has the desired scan characteristic through the network based on the analysis result to the members;
each scanner having the desired scan characteristic transmitting an answer to the user terminal that transmits the query; and
the user terminal transmitting the query registering itself in each scanner transmitting the answer,
wherein the advertisement can be updated periodically.

6. The method of claim 3, wherein step (c3) comprises:
each user terminal registered as the member designating the desired scanner among the scanners in which the user terminal has been registered;
determining whether the designated scanner is performing a scan;
when it is determined that designated scanner is not performing a scan, reserving the designated scanner that is not performing a scan; and
the reserved scanner informing the members that it has been reserved,
wherein the reserved scanner rejects reservation made by another user terminal.

7. The method of claim 3, further comprising:
the designated scanner determining whether the user terminal making reservation for the designated scanner has not used the designated scanner for a third predetermined time;
if it is determined that the user terminal has not used the designated scanner for the third predetermined time, canceling the reservation; and
the scanner whose reservation has been canceled informing the members that it is available for reservation.

8. The method of claim 1, wherein in step (d), each reserved scanner informs the members of the beginning of the scan and the scan characteristic when it starts the scan and informs the member that it is available for reservation when it terminates the scan.

9. The method of claim 8, wherein step (d) comprises transmitting the scan result to only a user terminal that wants to receive the scan result among user terminals that have received the beginning of the scan and the scan characteristic.

10. The method of claim 1, further comprising:
determining whether the scan result has not been completely received;
if it is determined that the scan result has not been completely received, a user terminal that has not completely received the scan result determining whether a fourth predetermined time has lapsed;
if it is determined that the fourth predetermined time has lapsed, the user terminal that has not completely received the scan result informing the scanner performing the scan and user terminals indicated by the device multicast address of the scanner performing the scan that the scan result has not been completely received; and
among the scanner and the user terminals that are informed that the scan result has not been completely received, the scanner and user terminals that have stored the scan result that has not been completely received transmitting the scan result to destinations indicated by the device multicast address of the scanner performing the scan.

11. The method of claim 10, wherein the fourth predetermined time is determined using a coded unique number of the user terminal that has not completely received the scan result.

12. The method of claim 1, further comprising user terminals registered in one scanner conversing or exchanging information with each other using the device multicast address of the scanner in which the user terminals are registered.

13. The method of claim 1, wherein each user terminal informs a user of at least one among its state and a state of the scanner.

14. A network scanning apparatus comprising a network, at least one scanner and at least one user terminal which are connected through the network,
wherein the network is adapted to register user terminals and scanners, which are indicated by a management multicast address, as members;
wherein the at least one scanner is adapted to determine a device multicast address, advertise itself, register user terminals, receive a document from a user terminal reserving itself, scan the received document, and transmit a scan result to at least one user terminal indicated by the device multicast address; and
wherein the at least one user terminal is adapted to determine one or more scanners having a desired scan characteristic using each advertisement received from at least one scanner registered as a member, register itself in each of the determined one or more scanners, and designate and reserve a desired scanner among the determined one or more scanners in which the user terminal is registered.

15. The network scanning apparatus of claim 14, wherein each scanner comprises:
an address existence verifier which verifies whether one or more addresses which can be selected exist among address of user terminals connected to the address existence verifier through the network and outputs a verification result as a first control signal;
an address selector which randomly selects an address among the one or more addresses which can be selected in response to the first control signal;
an address use verifier which verifies whether the selected address is being used by another scanner or a user terminal and outputs a verification result as a second control signal;
a first time checker which checks whether a first predetermined time has lapsed in response to the second control signal and outputs a check result as a third control signal;
an address determiner which determines the selected address as the device multicast address according to the third control signal; and
a second time checker which checks whether a second predetermined time has lapsed in response to the first control signal and outputs a check result as a fourth control signal,
wherein the address existence verifier also verifies whether one or more addresses which can be selected exist in response one of the second and fourth control signals, and then the address use verifier verifies whether an address selected by the address selector is being used by another scanner or a user terminal in response to the third control signal.

16. A packet format transmitted between a user terminal and a scanner through a network, the packet format comprising:
a first header in which a device multicast address is recorded; and
a second header in which a management multicast address is recorded.

17. The packet format of claim 16, further comprising a data portion in which data is selected from the group consisting of content of an advertisement, a desired scan characteristic, unique information on a user terminal to be registered, a state of the user terminal, a state of a scanner, and a scan result is recorded.

18. The packet format of claim 17, wherein the data portion comprises:
an N recording portion in which N is recorded;
first through N-th values;
first through N-th type portions; and
first through N-th length portions,
wherein data is recorded in the n-th value where 1≦n≦N, a type of the n-th value is recorded in the n-th type portion, and a length of the n-th value is recorded in the n-th length portion.

19. The packet format of claim 17, wherein the first header comprises:
a version portion in which a version of a communication protocol is recorded;
a scanner type portion in which a type of the scanner is recorded;
a packet type portion in which usage of a packet is recorded;
a request/response portion in which an attribute of the data is recorded; and
a flag portion in which an attribute of the first header is recorded.

20. The packet format of claim 19, wherein the flag portion comprises a compression code indicating compression or non-compression of the first header.

21. The packet format of claim 19, wherein the first header comprises:
a first address portion in which a device multiflag address is recorded; and
a second address portion in which a unique device address of the scanner is recorded.

22. The packet format of claim 21, wherein the unique device address is generated dynamically or passively.

23. The packet format of claim 19, wherein the first header further comprises a data signature portion in which a signature value obtained using a one-way hash function is recorded.

24. The packet format of claim 17, wherein the data portion comprises:
an identification portion in which a serial number of a segment of the scan result is recorded;
a time portion in which a time when the scan result is to be transmitted is recorded; and
a scan data portion in which the segment of the scan result is recorded.
